(19) United States
(12) Patent Application Publication
(10) Pub. No.: US 2005/0011772 A1
(43) Pub. Date: Jan. 20, 2005

(54) Multiple coin authentication system

(76) Inventor: Steven R. Eichenbaum, Bradenton, FL (US)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/695,575

(22) Filed: Oct. 28, 2003

Related U.S. Application Data
(60) Provisional application No. 60/487,204, filed on Jul. 14, 2003.

(51) Int. Cl. A45C 1/00; A61C 19/10

(52) U.S. Cl. 206/.8; 206/.84

(57) ABSTRACT

The present invention relates to a multiple coin authentication system in which a plurality of coins are attached to a core. The core includes a plurality of openings therein. Coupling means are used for expeditiously coupling the coins to the core. For example, the coupling means can be a flexible gasket surrounding the coins which gasket snaps into a corresponding opening in the core. An authentication certificate is also attached to the core. The core is received in a cavity of a case. The cavity is formed between a top and bottom. The top and bottom are ultrasonically bonded together. The case is designed to include means for positively indicating sealing of the top to the bottom which means form a visible irreparable condition of the case indicative of tampering.

### CROSS REFERENCE TO RELATED APPLICATION

This application claims the benefit of U.S. Provisional Patent Application No. 60/487,204, filed Jul. 14, 2003, the entirety of which is hereby incorporated by reference into this application.

### BACKGROUND OF THE INVENTION

1. Technical Field

The present invention relates to a multiple coin authentication system, for holding a plurality of coins and providing positive evidence of tampering with the article.

2. Description of Related Art

Coin carriers are known. The broad concept for a holder for a coin appears to be known. U.S. Pat. No. 3,788,464 describes a holder for a coin in which a holder comprises a case and a member for holding the coin. The member is formed of a hole and at least three object-retaining portions, which extend inwardly into the hole. The member is formed of a deformable plastic. After the coin has been inserted into the member, the member is inserted between first and second parts of the case and the case is ultrasonically welded to provide a unitary assembly.

U.S. Pat. No. 4,878,579 describes a tamper proof coin case. The coin case includes a first and second planar member, which are ultrasonically welded together. A first retention zone is shaped to allow a coin to be retained. The first retention zone includes a diameter to reserve the coin. Nibs formed of a deformable plastic extending into the center zone are used to engage the coin. A second retention zone accommodates a photograph of the coin. A third retention zone accommodates a certificate providing identification and quality information about the coin.

U.S. Pat. No. 5,042,650 describes a transparent coin case having a plastic member having a recess for receiving a retention ring. The retention ring is a pliable plastic and includes a concentric aperture, which is sized to receive a desired coin. A certificate can be dispersed between the case members. The above described patents are directed to a single coin holder.

U.S. Pat. No. 2,139,150 describes a display board for a plurality of coins. The display board includes openings thereon and a pair of transparent members slightly larger than the opening and adapted to springably fit therein on either side of an inserted article.

It is desirable to provide an improved multiple coin authentication system for expeditiously coupling coins in a case and providing positive evidence of tampering with the article.

### SUMMARY OF THE INVENTION

The present invention relates to a multiple coin authentication system in which a plurality of coins are attached to a core. The core includes a plurality of openings therein. Coupling means are used for expeditiously coupling the coins to the core. For example, the coupling means can be a flexible gasket surrounding the coins which gasket snaps into a corresponding opening in the core. An authentication certificate is also attached to the core. The core is received in a cavity of a case. The cavity is formed between a top and bottom. The top and bottom are ultrasonically bonded together. The case is designed to include means for positively indicating sealing of the top to the bottom which means form a visible irreparable condition of the case indicative of tampering. Accordingly, when purchasing certified coins, the buyer can view the certificate to determine certification of the collectable article. Also, the buyer can view the case to determine evidence of tampering with the case.

The invention will be more fully described by reference to the following drawings.

### BRIEF DESCRIPTION OF THE DRAWINGS

FIG. 1 is a front perspective view of a multiple coin authentication system in accordance with the teachings of the present invention.

FIG. 2 is a front perspective view of a multiple coin authentication system including a certificate of grades for individual coins.

FIG. 3 is a perspective view of assembly of the multiple coin authentication system before insertion of coins into the multiple coin authentication system.

FIG. 4 is a rear perspective view of the multiple coin authentication system shown in FIG. 1.

FIG. 5 is a front perspective view of an alternate embodiment of the multiple coin authentication system.

FIG. 6 is a front perspective view of an alternate embodiment including more than one size of coins.

FIG. 7 is a front perspective view of an alternate embodiment including more than one size of coins.

FIG. 8 is a front perspective view of an alternate embodiment including more than one size of coins.

FIG. 9 is a front perspective view of an alternate embodiment including more than one size of coins.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

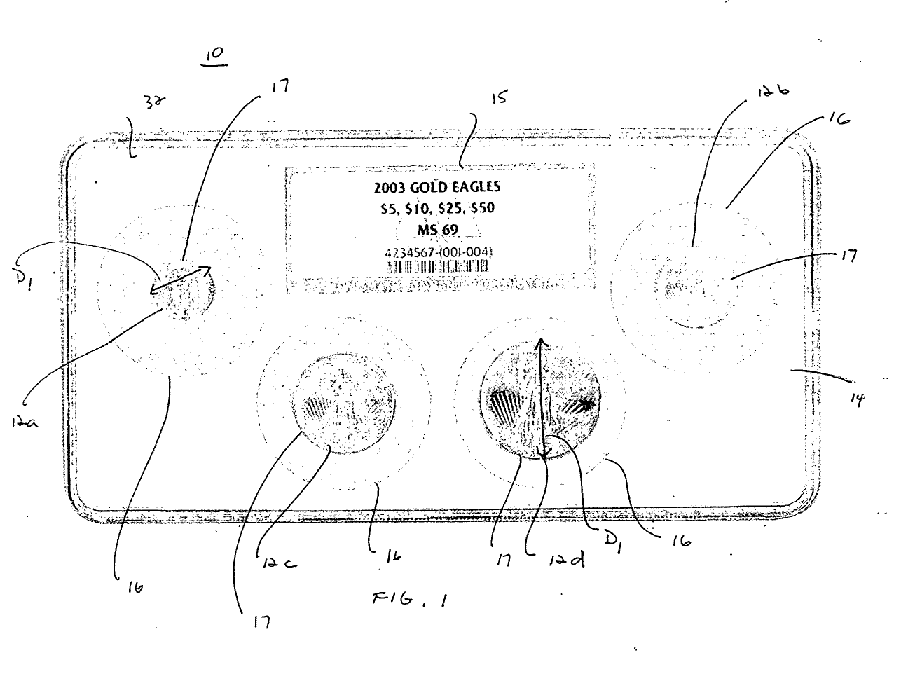

FIG. 1 illustrates a perspective view of multiple coin authentication system 10 in accordance with the teachings of the present invention. A plurality of coins 12 are coupled to core 14. Certificate 15 is attached to core 14. Certificate 15 can include certification indicia representing an indicator of the coins identity and quality, such as by the Numisamtic Guaranty Corporation system of evaluation. Certificate 15 can include pressure adhesive strips on the bottom surface thereof for affixing certificate 15 as a label to core 14.

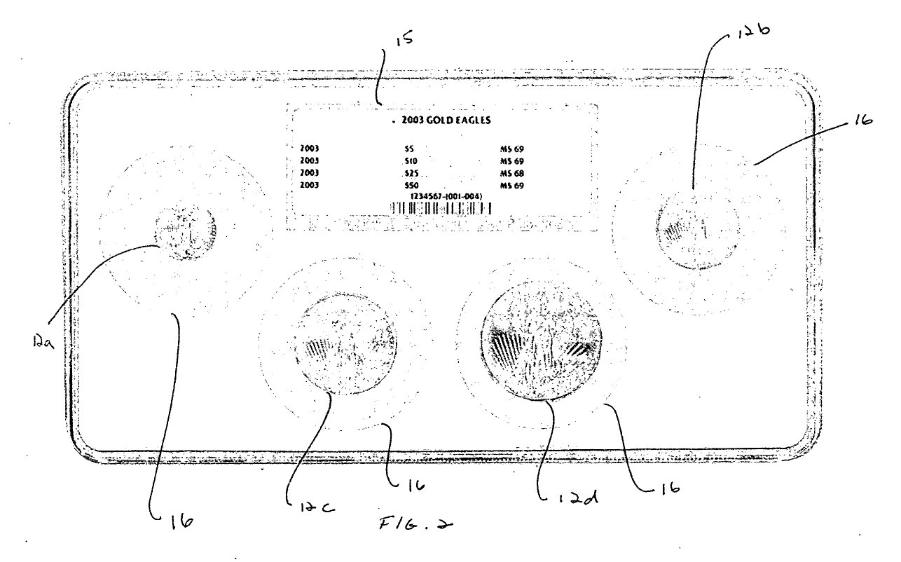

Certificate 15 can indicate a grade of each coin contained in system 10. Certificate 15 can also include certification indicia such as an identification number or barcode. In this embodiment, certificate 15 indicated that each coin has the same grade, for example, MS69. In an alternate embodiment, certificate 15 can include the same or different grades for each of the coins 12, as shown in FIG. 2. For example, certification indicia in certificate 15 can indicate coin 12a has a $5.00 value and a grade of MS69, coin 12b has a $10.00 value and a grade of MS69, coin 12c has a $25.00 value and a grade of MS68 and coin 12d has a $50.00 value and a grade of MS69.

Coins 12 can be coupled to core 14 using flexible gasket 16. Flexible gasket 16 includes opening 17 for receiving coin 12. Alternatively, gasket 16 includes a depression for receiving coin 12. Diameter D₁ of opening 17 is sized to tightly fit around received coin 12. For example, diameter D₁ of opening 17 is larger to receive larger coin 12d and diameter D₁ is smaller to receive smaller coin 12a.

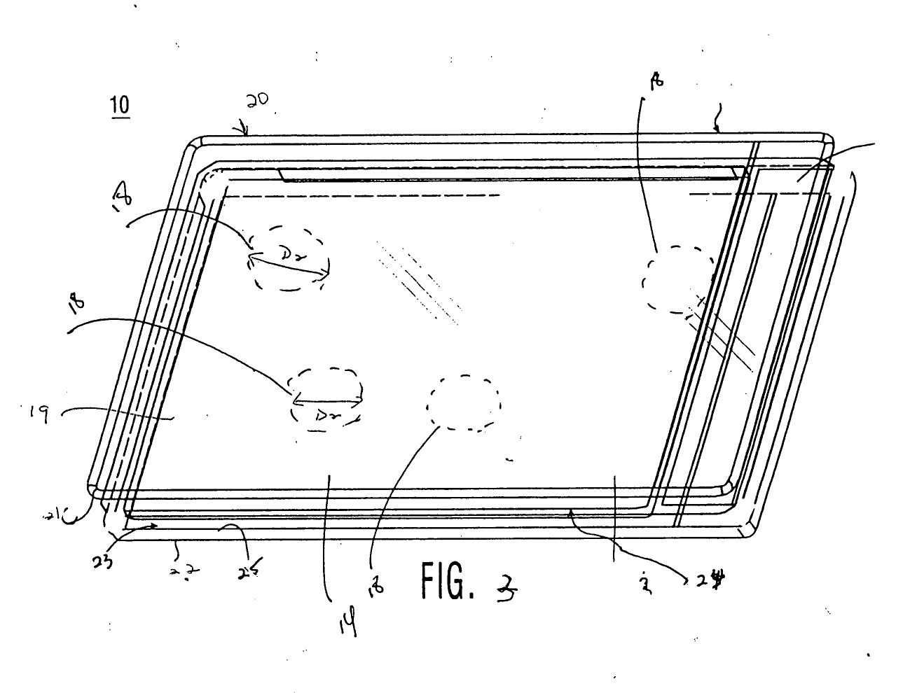

Core 14 includes a plurality of openings 18 in substrate 19 for receiving coins 12, as shown in FIG. 3. Openings 18 have a diameter D₂ sized to receive flexible gasket 16. Flexible gasket 16 snaps into one of openings 18 for expeditious attachment of coin 12 to core 14, as shown in FIG. 1.

Core 14 can be formed of a plastic or thermoplastic material, such as rubber. Suitable materials for flexible gasket 16 include flexible thermoplastic materials such as ethylene vinyl acetate, copolymer or terpolymer, rubber, styrene butadiene copolymer and the like.

Core 14 is received in case 20, as shown in FIG. 3. Case 20 is formed of top 21 and bottom 22. Cavity 23 is formed within inner wall 24 of top 21 and inner wall 25 of bottom 22 after top 21 is attached to bottom 22. Top 21 and bottom 22 are formed of an appropriate size for receiving core 14 within cavity 23. Top 21 and bottom 22 can be formed of a plastic material. Top 21 and bottom 22 can be formed of a rigid material. Suitable materials for top 21 and bottom 22 include polyethylene terphthalate, polystyrene, polyvinyl chloride, polyester, polycarbonate, polypropylene or polyethylene and the like.

Top 21 and bottom 22 are interlocked together, thereby providing a permanent seal around core 14, as described in more detail below. Preferably, ultrasonic bonding is used to permanently seal top 21 to bottom 22, thereby enclosing core 14 within case 20. The procedure of ultrasonically bonding or welding plastic material is well known in the art and may be realized in any matter deemed appropriate for the practice of the invention disclosed herein. A compromised condition of case 20 indicates the positive seal between top 21 and bottom 22 has been broken, thereby indicating tampering of case 20. It will be appreciated that after case 20 is opened or compromised, the collectable article is no longer certified as authentic.

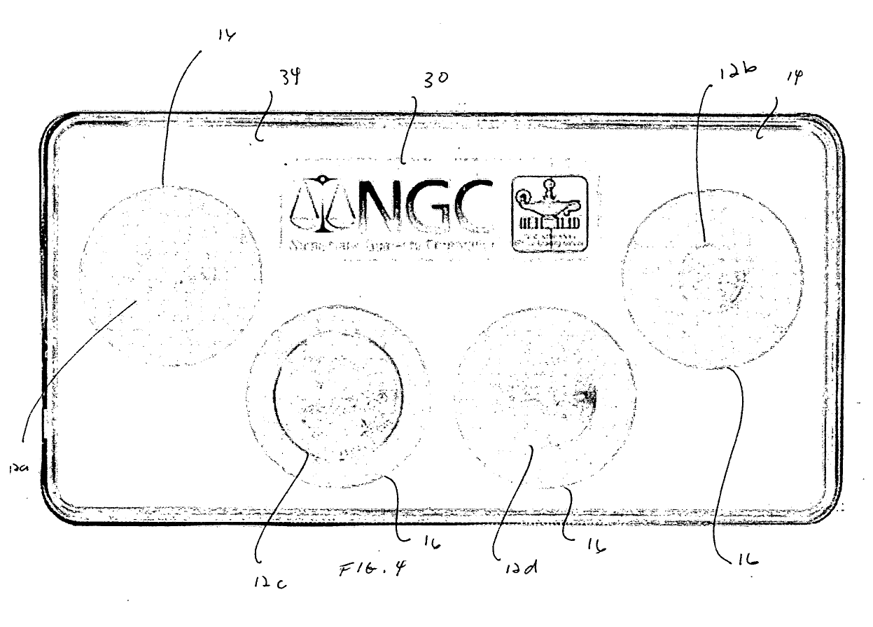

Hologram 30 can be attached to core 14. For example, certificate 15 is attached to front 32 of core 14, as shown in FIG. 1, and hologram 30 is attached to rear 34 of core 14, as shown in FIG. 4. Hologram 30 can provide an identification of the entity performing the certification which provides certificate 15. Hologram 30 is difficult to duplicate and provides authenticity that the certification ahs been prepared by the entity performing the certification.

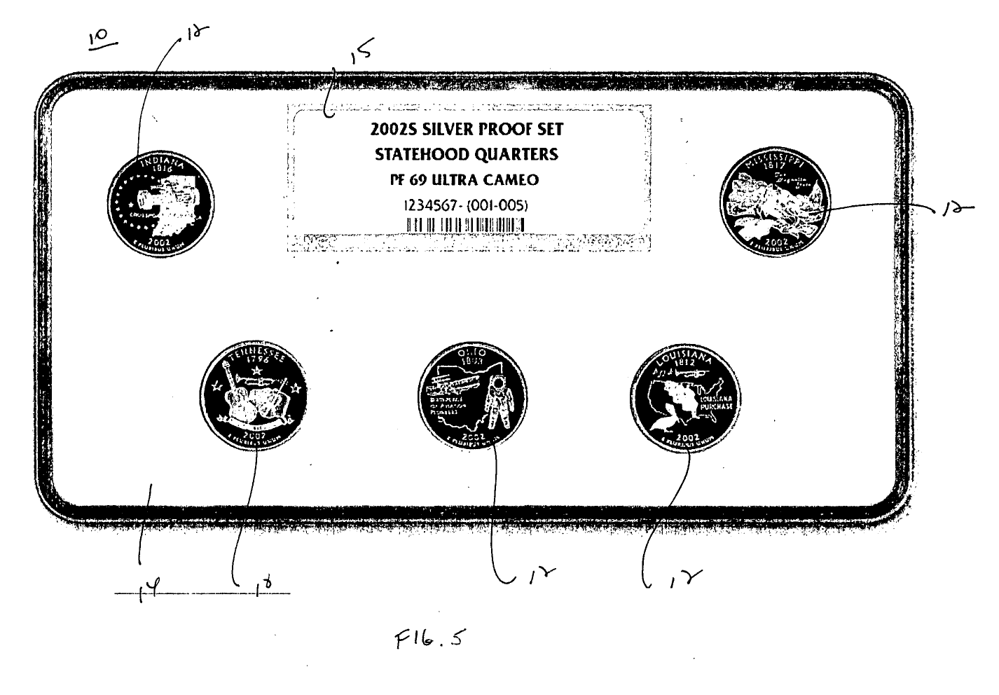

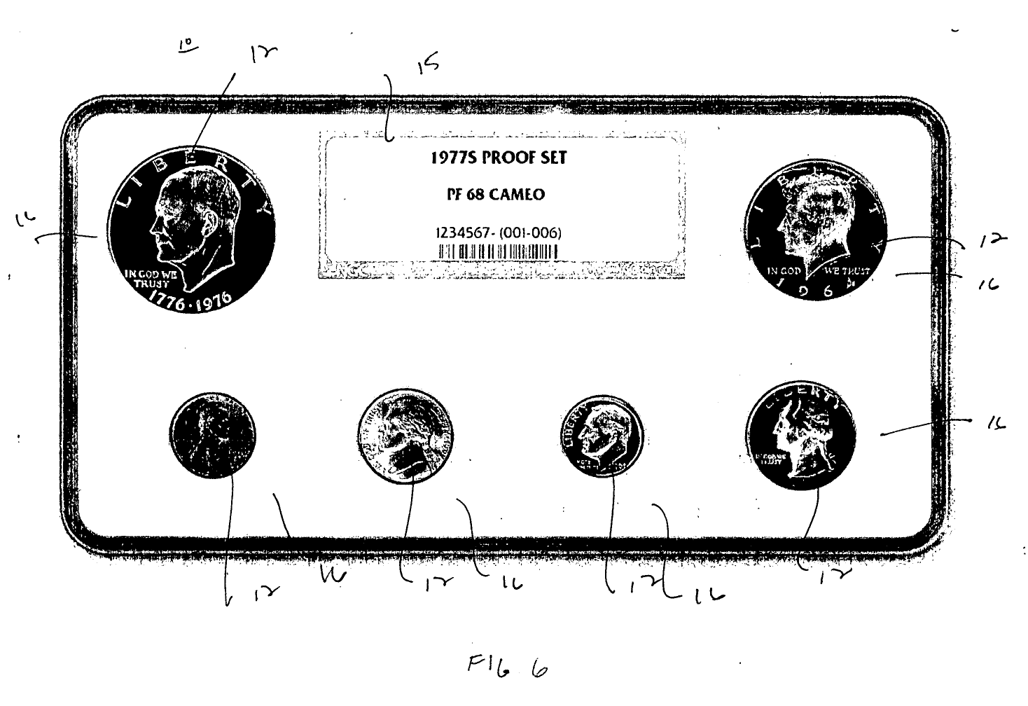

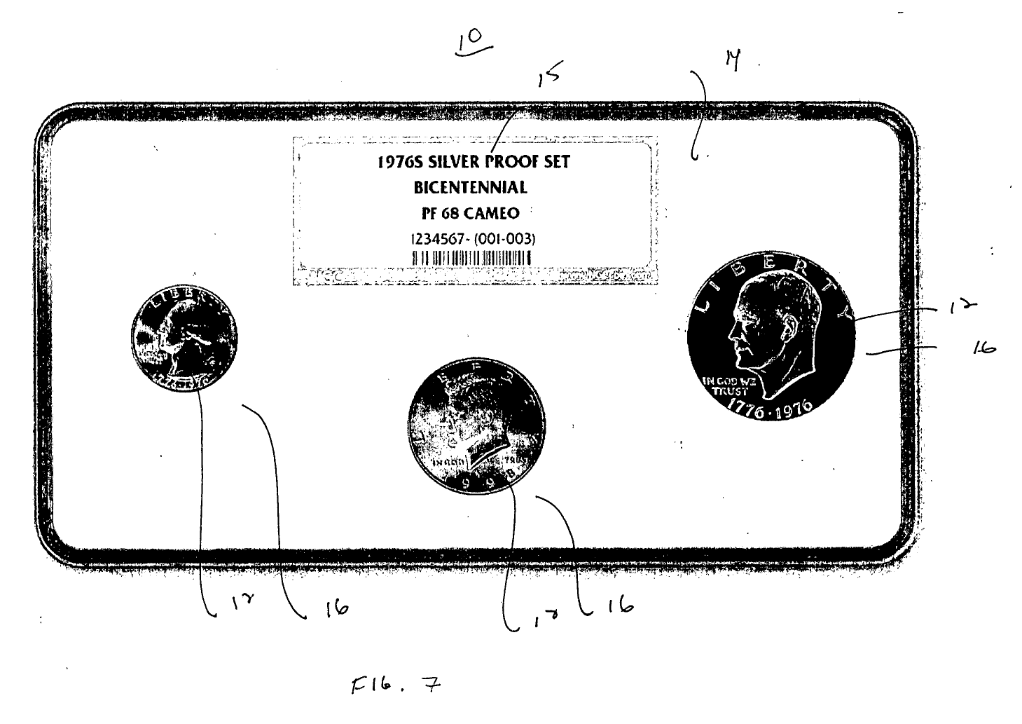

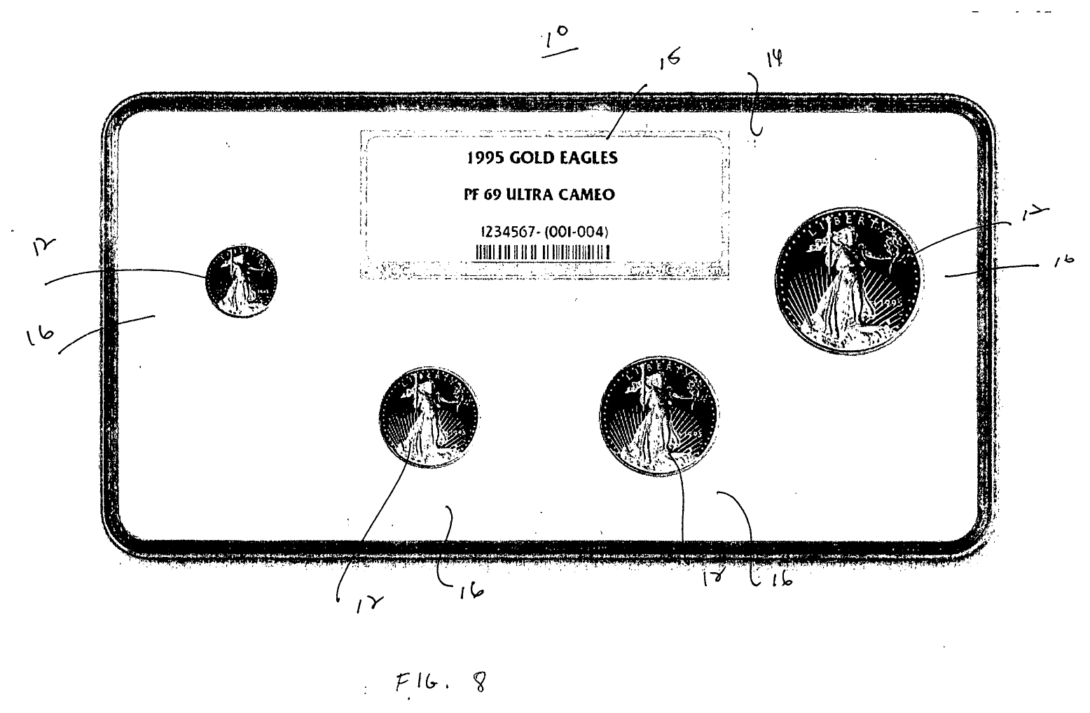

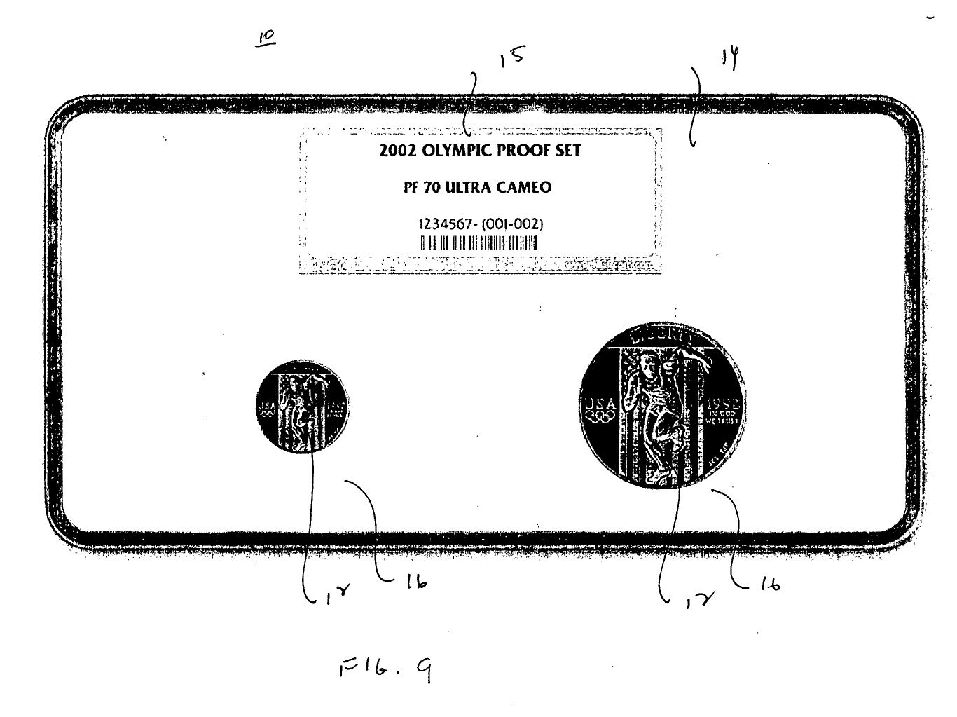

A predetermined number of openings 18 can be formed in core 14. Openings 18 in core 14 can be arranged to display a plurality of coins 12, as shown in FIG. 5. Openings 18 and gasket 16 can be appropriately sized to receive and couple various sized of coins 12 to core 14, as shown in FIGS. 6-9. Openings 18 can be arranged in various configurations to display a plurality of coins 12, as shown in FIGS. 6-9.

It is understood that the above-described embodiments are illustrative of only a few of the many possible specific embodiments which can represent applications of the principles of the invention. Numerous and varies other arrangement can be readily devised in accordance with these principles by those skilled in the art without departing from the spirit and scope of the invention.

1. A multiple coin authentication system comprising:
a core adapted for receiving a plurality of coins;
means for authenticating said coins being attached to said core;
a case having a top and a bottom, said case defining a cavity between said top and said bottom for receiving said core, said case being formed by ultrasonically welding said top and said bottom together, and
means for positively indicating sealing of said top to said bottom,
wherein tampering with said case forms a visible irreparable condition of said case indicative of tampering.

2. The system of claim 1 wherein said core comprises a substrate having a plurality of openings therein.

3. The system of claim 1 further comprising means for coupling each of said coins to a respective opening in said core.

4. The system of claim 3 wherein said means for coupling comprises a plurality of gaskets, each of said gaskets having an opening therein adapted to receive one of said coins, wherein each of said gaskets snap fits into a respective one of said openings.

5. The system of claim 4 wherein said gaskets are formed of a flexible material.

6. The system of claim 4 wherein said gaskets are formed of a material selected from the group consisting of ethylene vinyl acetate, rubber and styrene butadiene copolymer.

7. The system of claim 3 wherein said means for coupling comprises a plurality of gaskets, each of said gaskets having a depression therein adapted to receive one of said coins, wherein each of said gaskets snap fits into a respective one of said openings.

8. The system of claim 7 wherein said gaskets are formed of a flexible material.

9. The system of claim 8 wherein said gaskets are formed of a material selected from the group consisting of ethylene vinyl acetate, rubber and styrene butadiene copolymer.

10. The system of claim 1 wherein said means for authenticating said coins comprises:
a certificate coupled to said core.

11. The system of claim 10 wherein said certificate is affixed with a pressure sensitive adhesive on bottom surface of said certificate to said core and a top surface of said certificate includes certification indicia.

12. The system of claim 11 wherein said certification indicia includes a grade of each of said coins in the system.

13. The system of claim 11 wherein at least one of said grade of each of said coins in the system is different from another of said grade of each of said coins in the system.

14. The system of claim 11 wherein each said grade of each of said coins in the system is the same for all of said coins.

15. The system of claim 10 wherein said means for authenticating said coin further comprises a hologram coupled to said core.

16. The system of claim 1 wherein said top and said bottom of said case are formed of plastic.

17. The system of claim 1 wherein said top and said bottom of said case are formed of a rigid material.

18. The system of claim 1 wherein said means for positively indicating sealing of said top to said bottom comprises means for ultrasonically bonding said top to said bottom.

19. A method for authenticating multiple coins comprising:
coupling to said multiple coins to a core;
coupling a certificate to said core;
placing said core between a top and a bottom of a case; and
sealing said top and said bottom of said case by ultrasonic bonding,
wherein said case includes means for positively indicating sealing of said top to said bottom.

20. The method of claim 19 wherein said core comprises a substrate having a plurality of openings therein, said coupling step comprises using a plurality of gaskets, each of said gaskets having an opening therein adapted to receive one of said coins, wherein each of said gaskets snap fits into a respective one of said openings.

21. The method of claim 20 wherein said gaskets are formed of a flexible material.

22. The method of claim 20 wherein said gaskets are formed of a material selected from the group consisting of ethylene vinyl acetate, rubber and styrene butadiene copolymer.

23. The method of claim 19 wherein said certificate includes certification indicia of a grade of each of said coins in the system.

24. The method of claim 19 wherein at least one of said grade of each of said coins in the system is different from another of said grade of each of said coins in the system.

25. The method of claim 19 wherein each said grade of each of said coins in the system is the same for all of said coins.
